(19) United States
(12) Patent Application Publication
(10) Pub. No.: US 2001/0031063 A1
(43) Pub. Date: Oct. 18, 2001

(54) Loudspeaker free flow cooling system

(76) Inventors: Jassa Langford, Oklahoma City, OK (US); Diane Franke, Oklahoma City, OK (US)

Correspondence Address: JASSA LANGFORD, 912 N. Classen, Oklahoma City, OK, 73106, US

(21) Appl. No.: 09/739,894

(22) Filed: Dec. 20, 2000

Related U.S. Application Data
(60) Provisional application No. 60/172,936, filed on Dec. 21, 1999.

(51) Int. Cl. H04R 1/00; H04R 11/02

(52) U.S. Cl. 381/397; 381/420

(57) ABSTRACT

A loudspeaker having an air cooled voice coil. The speaker includes frame, a cone and a cap collectively forming a vibratingly drivable diaphragm, a magnet, a pole piece, a voice coil disposed to drive the diaphragm, and preferably a spider disposed to secure the diaphragm to the frame at one end of the diaphragm. The magnet is part of a magnet assembly having air passages disposed to enable air to flow over the voice coil, and to be efficiently conducted away therefrom. The voice coil has apertures enabling cooling air to flow from the air passages in close, heat exchange relation to the voice coil. In alternative embodiments, the air passages extend horizontally and vertically through the magnet assembly, and may interconnect. Preferably, the diaphragm acts to pressurize air to establish flow for cooling purposes. In alternative embodiments, independent sources of pressurized air are contemplated.

### REFERENCE TO RELATED APPLICATION

This application claims benefit of priority of Provisional Patent Application Ser. No. 60/172,936, filed Dec. 21, 1999.

### BACKGROUND OF THE INVENTION

1. Field of the Invention

The present invention relates to electromagnetic loudspeakers, and more particularly to air cooling of the same.

2. Description of the Prior Art

Electromagnetic loudspeakers of the type having an electrically energized voice coil and magnetically moved diaphragm suffer from a phenomenon known as power compression. That is, electrical current increases temperatures of affected components, which increase in temperature increases electrical resistance of current conductive components. The net effect of increased resistance is to lower effective or operative power of the speaker for a given level of electrical input.

One answer to this problem is to provide active cooling means for speakers. One approach is shown in U.S. Pat. No. 1,165,255, issued to Charles D. Herrold et al. on Dec. 21, 1915, which describes the use of circulating water to cool a speaker. Rather than using water, the present invention utilizes ambient air as a cooling medium.

U.S. Pat. No. 2,217,177, issued to Frank Massa on Oct. 8, 1940, and U.S. Pat. No. 2,270,787, issued to Willy Schulze et al. on Jan. 20, 1942, each provide for surrounding heat generating components of a loudspeaker with a thermally conductive gas such as hydrogen or helium. Use of a specific gas which is different from air requires that the selected gas be separated from ambient air by means such as having an enclosed circulation path. By contrast with the scheme of Massa, the present invention uses a circulation system of ambient air, which need not be enclosed.

U.S. Pat. No. 4,757,547, issued to Thomas J. Danley on Jul. 12, 1988, describes a forced air cooling system for a speaker wherein air is propelled past the voice coil. The device of Danley lacks the vents provided in the present invention.

U.S. Pat. No. 5,426,707, issued to Eddy L. L. Wijnker on Jun. 20, 1995, shows a speaker assembly provided with an air cooling system. The circulation scheme of Wijnker is different from that of the present invention.

The component of a loudspeaker most affected by electrical resistance heating is the voice coil, which includes an electrical conductor wound around a coil form. The voice coil occupies a narrow gap located between a pole piece and a magnet assembly. Ideally, cooling air would pass through this gap and over the voice coil. However, the gap is so small that it restricts effective air flow over the voice coil. Therefore, prior art cooling systems which rely heavily on air flow through this gap suffer from being severely limited in effectiveness. There remains a need for an effective air flow circulation system for loudspeakers.

None of the above inventions and patents, taken either singly or in combination, is seen to describe the instant invention as claimed.

### SUMMARY OF THE INVENTION

The present invention provides an air cooling system for a loudspeaker. Notably, the present invention provides a solution to impedance of flow of a cooling medium in the gap existing between the pole piece and the magnet assembly. In alternative embodiments, the cooling system utilizes components of the speaker to propel cooling air, the loudspeaker thus provided with the cooling system being self-cooled, or alternatively may have a separate source of propulsion of cooling air. Regardless of the source of cooling air, the novel loudspeaker is arranged to utilize the air flow effectively in dissipating heat generated by resistance within the voice coil.

This is accomplished by forming air passages throughout the sound generating components. In particular, the voice coil form bears openings so that cooling air can pass in close proximity past the voice coil conductor. This air passes through the pole piece and through the magnet and surrounding components. Therefore, air flow occurs in quantities sufficient to cause significant heat dissipation. This arrangement overcomes a bottleneck caused by severely restrictive magnitude of the gap occupied by the voice coil, as plagues prior art attempts to cool the voice coil by ventilation. The voice coil in the present invention is effectively cooled, and significant diminishing of power compression is achieved. Performance losses which would otherwise degrade audio output of the loudspeaker are therefore minimized.

Accordingly, it is a principal object of the invention to provide a loudspeaker which minimizes performance losses due to power compression.

It is another object of the invention to provide effective cooling of the voice coil.

It is a further object of the invention to utilize ambient air as a fluid cooling medium.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side cross section of one embodiment of the invention.

FIG. 2 is a side cross sectional detail view of a voice coil and holder shown at the center of FIG. 1, drawn to enlarged scale.

FIG. 3 is a side elevational detail view of an alternative embodiment of a magnet assembly of the novel loudspeaker, drawn to enlarged scale.

FIG. 4 is a top plan detail view of an alternative embodiment of the magnet assembly.

FIG. 5 is a top plan detail view of another alternative embodiment of the magnet assembly.

### DETAILED DESCRIPTION OF THE PREFERRED EMBODIMENTS

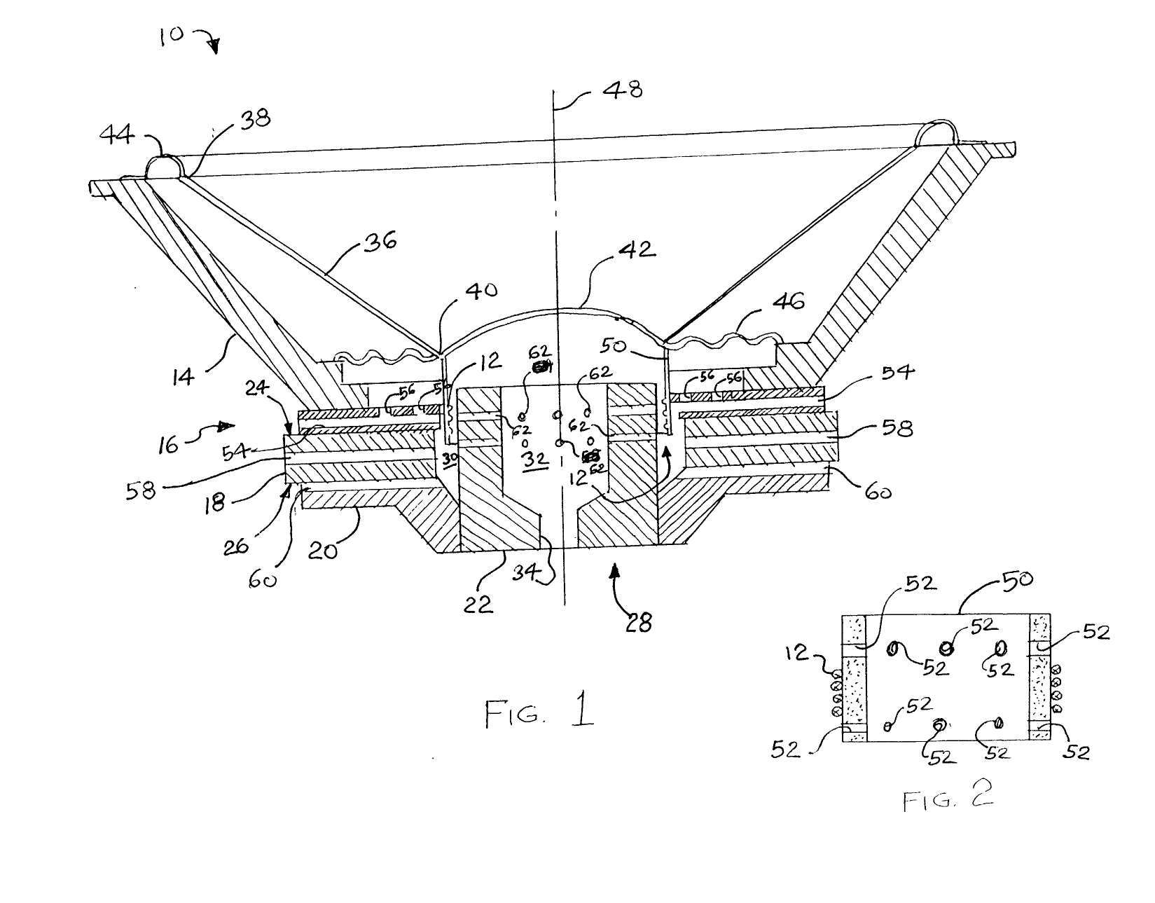

Turning now to FIG. 1 of the drawings, there is shown a loudspeaker 10 of the type which vibrates or drives a diaphragm by means of a variable electrical signal imposed on voice coil 12. Loudspeaker 10 includes a rigid structural frame 14 to which are mounted the diaphragm and a magnet assembly. The magnet assembly is fixed solidly to the frame, and includes a top plate 16, an annular permanent magnet 18, a back plate 20, and a pole piece 22. The components of the magnet assembly are all solidly fixed to one another in the order illustrated.

Magnet 18 has an upper end surface 24 and a lower end surface 26. Top plate 16 is located between frame 14 and magnet 18, and abuts magnet 18 at upper end surface 24. Back plate 20 abuts magnet 18 at lower end surface 26. Top plate 16, magnet 18, and back plate 20 are generally annular, surrounding and defining a central opening 28. Pole piece 22 occupies central opening 28. An annular gap 30 is located outside pole piece 22 between the latter and the remaining components of the magnet assembly. Pole piece 22 is seen to have a central chamber 32 which opens upwardly and a passage 34 which communicates between chamber 32 and the open atmosphere below loudspeaker 10, as depicted in FIG. 1. Chamber 32 and passage 34 collectively extend the full vertical length of the magnet assembly, as depicted in FIG. 1. It follows that propelled air can be conducted through the magnet assembly in vertical directions.

The diaphragm assembly comprises a cone 36 having an open upper or major periphery 38 and a lower or minor periphery 40 which minor periphery 40 is closed by a cap 42. The diaphragm is secured to frame 14 at major periphery 38 by a flexible membrane 44, and by a spider 46 connecting cone 36 to a lower portion of frame 14. Membrane 44 and spider 46 are so configured and constituted that the diaphragm can vibrate responsive to interaction of voice coil 12 with the magnet assembly when electrical signals are conducted to coil 12. In so doing, the diaphragm is constrained to move only axially relative to central opening 28. The axial direction is indicated by axis 48.

The diaphragm is driven in conventional vibratory fashion by voice coil 12, which voice coil 12 is mounted securely to a voice coil form 50. Voice coil 12 is electrically conductive, being fabricated for example from copper wire. Voice coil form 50 and hence voice coil 12 can move within gap 30 axially with respect to central opening 32 and axis 48. The components of loudspeaker 10 are generally conventional in their function and constituent materials. Novelty resides in air cooling features which will now be described.

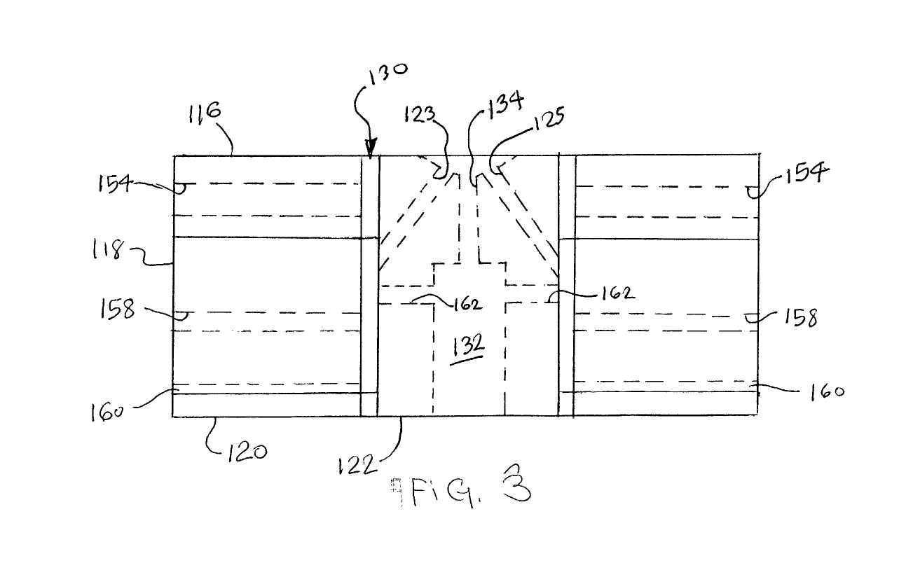

Turning momentarily to FIG. 2, it will be seen that voice coil form 50 has a plurality of apertures 52 formed therein. Similarly, and returning to FIG. 1, the magnet assembly also has air passages formed therein. Top plate 16 has air passages 54 extending radially therethrough, and vertical air passages 56. As employed herein, “radial” is relative to chamber 32 and axis 48.

Furthermore, as employed herein regarding orientation of air passages, the term “radial” will be understood to signify that there is a radial component of an air passage, when the arrangement of passages is analyzed geometrically, or is considered in light of an orthogonal system. An air passage could bear, for example, tangential orientation to the magnet assembly or pole piece. There is no requirement that a radial passage extend to the outer limits of the magnet assembly. It could as an alternative terminate at a non-radial passage which enables cooling air to be discharged to the exterior of the magnet assembly. It will further be understood that an air passage described as extending through a component will be arranged to enable discharge of cooling air to the exterior of the magnet assembly either by virtue of termination at the outer bounds of the magnet assembly or by intersection with a passage which ultimately communicates with the outer bounds of the magnet assembly.

Air passages 56 intersect passages 54, which passages 54 open to gap 30 and to the exterior of loudspeaker 10. Magnet 18 has radial air passages 58, and back plate 20 is configured to form radial air passages 60. Pole piece 22 has radial passages 62 which communicate between chamber 32 and gap 30.

In actual practice, gap 30 is of very limited magnitude, and would not permit significant cooling from air passing therethrough. Gap 30 and its counterparts in other embodiments are shown exaggerated for clarity in the accompanying drawing figures. Therefore it must be understood that air circulation in the horizontal direction, as depicted herein, is considerably more significant than is vertical air circulation occurring in gap 30 and its counterparts.

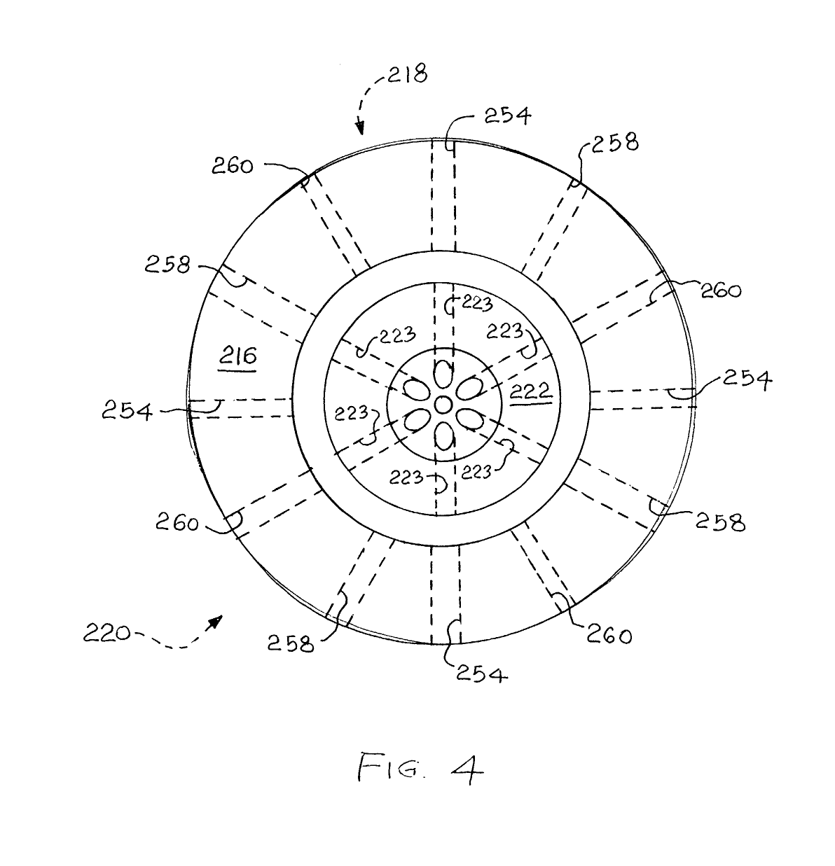

FIG. 3 shows an alternative embodiment of the magnet assembly illustrating a radiant arrangement of air passages which is not purely horizontal, as seen in FIG. 1. In FIG. 3, top plate 116 has horizontal air passages 154, magnet 118 has horizontal air passages 158, and back plate 120 has horizontal air passages 160. However, pole piece 122 has inclined air passages 123, 125. In other respects, pole piece 122 is similar to pole piece 22 of FIG. 1, having an internal chamber 132 and a vertical passage 134, as well as horizontal passages 162. Passages 123, 125, 162, 154, 158, 160, and 162 communicate with gap 130 which corresponds in function to gap 30 of FIG. 1.

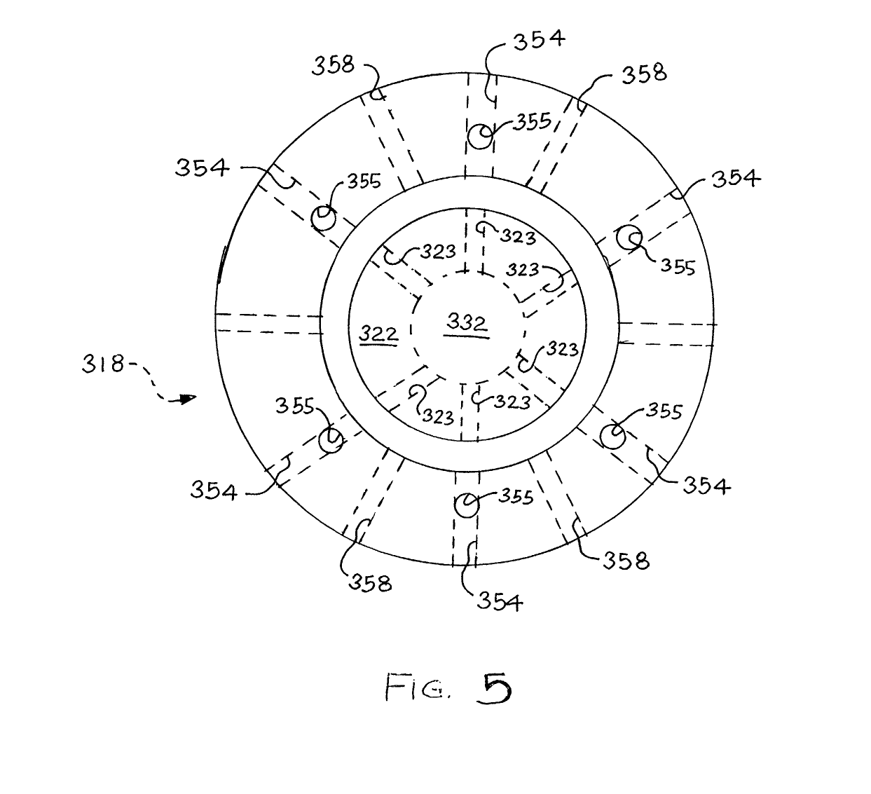

FIG. 4 illustrates an alternative embodiment of the magnet assembly wherein top plate 216 has radial air passages 254, magnet 218 has radial air passages 258, and back plate 220 has radial passages 260. Pole piece 222 has radial passages 223 each having an opening formed in an exposed upper surface of pole piece 222. The various radial air passages of any of the components of the embodiment of FIG. 4 may be inclined in the manner of passages 123 and 125 of FIG. 3 or alternatively may be horizontal in the manner of passages 154, 158, 160, and 162 of FIG. 3.

FIG. 5 shows an embodiment of the magnet assembly wherein radial air passages 354 formed in top plate 316 intersect with vertical ventilation passages 355 also formed in top plate 316. In the embodiment of FIG. 5, magnet 318 has air passages 358. Pole piece 322 has radial air passages 323 and a central opening 332 which is functionally similar to opening 32 of FIG. 1. Although not shown, the magnet assembly could include a back plate having air passages.

In the various embodiments of the invention, it is preferred that air passages formed in the pole piece, such as passages 62 of FIG. 1, align or nearly align with corresponding air passages 54 and 58 formed in other components of the magnet assembly.

The system of air passages shown and described is clearly seen to be able to conduct pressurized air to and through apertures 52 of voice coil form 50 in close proximity to voice coil 12, and ultimately to discharge air to the exterior of loudspeaker 10. Close proximity signifies that air is conducted sufficiently close to voice coil 12 to effect heat exchange between voice coil 12 and air passing nearby.

Propulsive pressurizing of air is accomplished in any suitable manner. In a preferred embodiment, the diaphragm fulfills this function. As the diaphragm moves axially responsive to electrical signals imposed on voice coil 12, air trapped between cap 42 and pole piece 22 is subjected to compression, and migrates downwardly, as depicted in FIG. 1, into chamber 32 and then outwardly. Some of this air will flow through the various air passages, be forced through apertures 52 past voice coil form 50 and voice coil 12, and will carry away heat generated in the latter.

It will be understood that pressurization of air by the diaphragm will be accompanied by all necessary structure to accomplish operable, effective air circulation as described. This may include, for example, one or more check valves (not shown) and other devices which assure discharge of heated air or which preclude ineffectual circular air flow paths.

The ventilation schemes encompassed by the present invention may be practiced with other sources of pressurized air. Illustratively, a powered blower may be operably connected to the loudspeaker.

The invention is susceptible to variations and modifications which may be introduced thereto without departing from the inventive concept. It is to be understood that the present invention is not limited to the embodiments described above, but encompasses any and all embodiments within the scope of the following claims.

We claim:

1. A loudspeaker having:
a structural frame;
a magnet assembly fixed to said frame, including an annular permanent magnet having a first end surface and an opposed second end surface, a top plate disposed between said frame and first end surface of said magnet, a back plate disposed at said second end surface of said magnet, wherein said top plate, said permanent magnet, and said back plate surround and define a central opening, and a pole piece disposed to occupy said central opening, wherein said pole piece is fixed to said magnet assembly, there being an annular gap located outside said pole piece; and
a diaphragm assembly secured to said frame such that said diaphragm can vibrate and is constrained to move only axially relative to said central opening of said magnet assembly, comprising a cone having an open major periphery supported on said frame and a minor periphery supported on said frame, wherein said minor periphery is closed by a cap, a voice coil form connected to said diaphragm assembly in vibratory driving relationship thereto, and an electrically conductive voice coil disposed around said voice coil form, wherein said voice coil can move within said annular gap axially with respect to said central opening of said magnet assembly,
wherein said voice coil form has apertures formed therein and said magnet assembly has air passages formed therein, and said air passages are disposed to conduct pressurized air through said apertures of said voice coil form in close proximity to said voice coil.

2. The loudspeaker according to claim 1, further comprising a flexible membrane disposed to connect said major periphery of said cone to said frame, and a spider disposed to connect said minor periphery of said cone to said frame.

3. The loudspeaker according to claim 1, wherein said central opening of said magnet assembly extends the full length of said magnet assembly, and can conduct propelled air through said magnet assembly.

4. The loudspeaker according to claim 1, wherein said diaphragm is disposed to pressurize air located between said diaphragm and said pole piece such that said air is forced into said apertures of said voice coil form in heat exchange relation to said voice coil.

5. The loudspeaker according to claim 1, wherein said air passages of said magnet assembly includes first air passages which are radial with respect to said central opening of said magnet assembly.

6. The loudspeaker according to claim 5, wherein said air passages include second air passages intersecting said first air passages and extending vertically through said top plate.

7. The loudspeaker according to claim 5, wherein at least some of said first air passages are disposed within said permanent magnet.

8. The loudspeaker according to claim 5, wherein at least one of said first air passages extends horizontally through said permanent magnet.

9. The loudspeaker according to claim 5, wherein at least one of said first air passages extends horizontally through said top plate.

10. The loudspeaker according to claim 5, wherein at least some of said first air passages are disposed within said back plate.
